(19) United States
(12) Patent Application Publication
(10) Pub. No.: US 2010/0246316 A1
(43) Pub. Date: Sep. 30, 2010

(54) DISPENSER, KIT AND MIXING ADAPTER

(75) Inventor: Yves A. Delmotte, Neufmaison (BE)

Correspondence Address: MARSHALL, GERSTEIN & BORUN (BAXTER), 233 SOUTH WACKER DRIVE, 6300 WILLIS TOWER, CHICAGO, IL, 60606-6357, US

(73) Assignees: BAXTER INTERNATIONAL INC., Deerfield, IL (US); BAXTER HEAL THCARE S.A., Zurich (CH)

(21) Appl. No.: 12/415,491

(22) Filed: Mar. 31, 2009

(51) Int. Cl. B01F 15/02

(52) U.S. Cl. 366/133

(57) ABSTRACT

A system includes a source of at least a first component, and a mixer having an inlet coupled to the source of at least a first component and an outlet, the mixer including at least one mixing device and a source of at least a second component disposed between the inlet and the outlet. The at least one mixing device includes a three-dimensional lattice defining a plurality of tortuous, interconnecting passages therethrough. The at least one mixing device has physical characteristics to sufficiently mix the first and second components, which characteristics include a selected one or more of mean flow pore size, thickness and porosity. Also disclosed are a kit defined by the source and the mixer, in the form of a mixer adapter, and the mixer adapter alone.

### BACKGROUND

This patent relates to a system for mixing an at least two-component system. In particular, this patent relates to a system for mixing at least a first component received from a source with at least a second component disposed between the inlet and the outlet of a mixer, and to a kit and a mixer adapter that provides such mixing.

In the medical field, and more particularly in the field of tissue sealants used to seal or repair biological tissue, a sealant is typically formed from two or more components that, when mixed, form a sealant having sufficient adhesion for a desired application, such as to seal or repair skin or other tissue. Such sealant components are preferably biocompatible, and can be absorbed by the body, or are otherwise harmless to the body, so that they do not require later removal. For example, fibrin is a well known tissue sealant that is made from a combination of at least two primary components—fibrinogen and thrombin, which have, depending on the temperature, viscosities of about 90-300 cps and 5 cps, respectively. Upon coming into contact with each other, the fibrinogen and thrombin components interact to form the tissue sealant fibrin, which is extremely viscous.

Sealant components may be kept in separate containers so as to be combined only just prior to application. However, because sealant components such as fibrinogen and thrombin have different viscosities, a complete and thorough mixing is often difficult to achieve. If the components are inadequately mixed, then the efficacy of the sealant to seal or bind tissue at the working surface may be compromised.

Inadequate mixing of the type described above is also a problem present in other medical and/or non-medical fields, where two or more components having relatively different viscosities are required to be mixed together. Such components may tend to separate from each other prior to use or be dispensed in a less than thoroughly mixed stream, due at least in part to their different viscosities, flow rates and depending on the temperature and amount of time such mixture may be stored prior to use.

To overcome the difficulties of the formation of the highly viscous fibrin in the medical field, in providing tissue sealant, it has become common to provide in-line mixing of the two or more components—in lieu of batch or tank mixing of the components. Some sealant products that may provide suitable mixtures include FLOSEAL, COSEAL, TISSEEL and ARTISS sealants from Baxter Healthcare Corporation, OMINEX sealants from Johnson & Johnson and BIOGLUE sealants from Cryolife, Inc. Such sealant may be applied by a dispenser that ejects sealant directly onto the tissue or other substrate or working surface. Examples of tissue sealant dispensers are shown in U.S. Pat. Nos. 4,631,055, 4,846,405, 5,116,315, 5,582,596, 5,665,067, 5,989,215, 6,461,361 and 6,585,696, 6,620,125 and 6,802,822 and PCT Publication No. WO 96/39212, all of which are incorporated herein by reference. Further examples of such dispensers also are sold under the Tissomat® and Duploject® trademarks, which are marketed by Baxter AG. Typically, in these prior art devices, two individual streams of the components fibrinogen and thrombin are combined and the combined stream is dispensed to the work surface. Combining the streams of fibrinogen and thrombin initiates the reaction that results in the formation of the fibrin sealant. While thorough mixing is important to fibrin formation, fouling or clogging of the dispenser tip may interfere with proper dispensing of fibrin. Such clogging or fouling may result from contact or mixing of the sealant components in a dispenser for an extended period of time prior to ejection of the sealant components from the dispensing tip.

In current mixing systems, the quality of mixing of two or more components having different viscosities may vary depending on the flow rate. For example, under certain flow conditions, the components may be dispensed as a less than thoroughly mixed stream. Accordingly, there is a desire to provide a mixing system which is not dependent on the flow rate to achieve sufficient mixing. Although prior devices have functioned to various degrees in forming and dispensing mixtures, there is a continuing need to provide a mixer and dispensing system that provides reliable and thorough mixing of at least two components (such as, for example, for a tissue sealant) for application to a desired work surface or other use applications in other fields.

Such a mixing system could be provided to dispense the mixture just prior to or at least in close proximity to its intended use or application. Preferably, such a mixer and dispensing system would also avoid undue fouling or clogging of the dispenser.

As set forth in more detail below, the present disclosure sets forth an improved assembly embodying advantageous alternatives to the conventional devices and approaches discussed above.

### SUMMARY

According to an aspect of the present disclosure, a system includes a source of at least a first component, and a mixer having an inlet coupled to the source of at least a first component and an outlet, the mixer including at least one mixing device and a source of at least a second component disposed between the inlet and the outlet. The at least one mixing device includes a three-dimensional lattice defining a plurality of tortuous, interconnecting passages therethrough. The at least one mixing device has physical characteristics to sufficiently mix the first and second components, which characteristics include a selected one or more of mean flow pore size, thickness and porosity.

According to another aspect of the present disclosure, a dispenser kit includes a source of at least a first component, and a mixer adapter having an inlet adapted to be coupled to the source of at least a first component and an outlet, the mixer adapter including at least one mixing device and a source of at least a second component disposed between the inlet and the outlet. The at least one mixing device includes a three-dimensional lattice defining a plurality of tortuous, interconnecting passages therethrough. The at least one mixing device has physical characteristics to sufficiently mix the first and second components, which characteristics include a selected one or more of mean flow pore size, thickness and porosity.

According to a further aspect of the present disclosure, a mixer adapter has an inlet adapted to be coupled to a source of at least a first component and an outlet. The mixer adapter includes at least one mixing device and a source of at least a second component disposed between the inlet and the outlet. The at least one mixing device includes a three-dimensional lattice defining a plurality of tortuous, interconnecting passages therethrough, and has physical characteristics to sufficiently mix the first and second components, which characteristics include a selected one or more of mean flow pore size, thickness and porosity

Additional aspects of the disclosure are defined by the claims of this patent.

### BRIEF DESCRIPTION OF THE FIGURES

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a plan view of a dispenser system according to the present disclosure;

FIG. 2 is a cross-sectional view of the dispenser system of FIG. 1 taken about line 2-2;

FIG. 3 is an enlarged, cross-sectional view of the mixer included in the dispenser system of FIG. 1;

FIG. 4 is an end view of the mixer of FIG. 3;

FIG. 5 is a scanning electron picture showing a lateral cross section of a sintered polypropylene material having a width of approximately 8.0 millimeters (mm) and a thickness of about 1.0 mm at about ×30 magnification;

FIG. 6 is a scanning electron picture showing a lateral cross section of a sintered polypropylene material having a width of approximately 8.0 millimeters (mm) and a thickness of about 1.0 mm at about ×100 magnification;

FIG. 7 is a scanning electron picture showing a lateral cross section of a sintered polypropylene material having a width of approximately 8.0 millimeters (mm) and a thickness of about 1.0 mm at about ×350 magnification;

FIG. 8 is a scanning electron picture showing a lateral cross section of a sintered polypropylene material having a width of approximately 8.0 millimeters (mm) and a thickness of about 1.0 mm at about ×200 magnification;

FIG. 9 is a scanning electron picture showing a longitudinal cross section of a sintered polypropylene material having a width of approximately 8.0 millimeters (mm) and a thickness of about 1.0 mm at about ×30 magnification;

FIG. 10 is a scanning electron picture showing a longitudinal cross section of a sintered polypropylene material having a width of approximately 8.0 millimeters (mm) and a thickness of about 1.0 mm at about ×100 magnification;

FIG. 11 is a scanning electron picture showing a longitudinal cross section of a sintered polypropylene material having a width of approximately 8.0 millimeters (mm) and a thickness of about 1.0 mm at about ×250 magnification;

FIG. 12 is a scanning electron picture showing a longitudinal cross section of a sintered polypropylene material having a width of approximately 8.0 millimeters (mm) and a thickness of about 1.0 mm at about ×350 magnification;

FIG. 13 shows porosity measurements of a selected material, of sintered polypropylene, obtained using a mercury porosity test;

FIGS. 14-15 are graphs showing a plot of permeability K values, pressure values and viscosity values relative to one another, based on Darcy's Law, with the remaining variable being held constant;

FIG. 16 is a cross-sectional view of an alternative mixer with the mixing devices spaced closer together than in the mixer of FIG. 3;

FIG. 17 is a cross-sectional view of an alternative mixer with the mixing devices spaced further apart than in the mixer of FIG. 3;

FIG. 18 is a cross-sectional view of an alternative mixer with an outlet attachment;

FIG. 19 is a plan view of a dispenser kit as assembled;

FIG. 20 is a cross-sectional view of the dispenser kit of FIG. 19, as assembled, taken about line 20-20;

FIG. 21 is an enlarged, fragmentary cross-sectional view of a mixer adapter included in the dispenser kit of FIG. 19, wherein a spacer disposed between the mixing devices is defined by an outer wall of the mixer adapter;

FIG. 22 is a plan view of the dispenser of FIG. 19 in combination with a container;

FIG. 23 is a plan view of an further alternative dispenser system including a source of sterile gas; and

FIG. 24 is a cross-sectional view of the dispenser system of FIG. 21 taken about line 24-24 in combination with a source of sterile gas;

FIG. 25 is a plan view of an outlet attachment for use with the dispenser system of FIG. 23;

FIG. 26 is a cross-sectional view of an alternative mixer adapter with male and female luer tip attachments; and

FIG. 27 is a cross-sectional view of a cannula-type device having a further alternative mixer according to the present disclosure.

### DETAILED DESCRIPTION

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

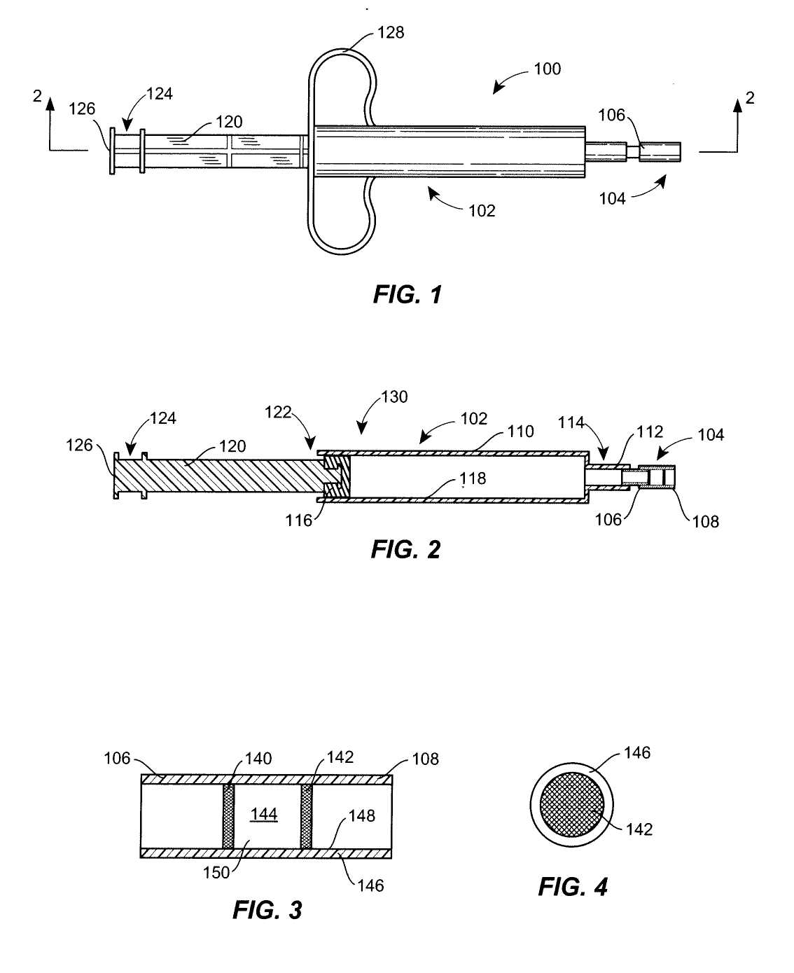

FIGS. 1-4 illustrate a dispenser system 100 according to the present disclosure. In general terms, the dispenser system 100 includes a source 102 of at least a first component of an at least two-component system. According to an exemplary embodiment, the first component may be fibrinogen. The dispenser system 100 also may include a mixer 104 coupled at an inlet 106 to the source 102 of at least a first component. As will be explained in greater detail below, the coupling of the mixer 104 to the source 102 may be a permanent attachment, through the use of an adhesive for example, or a releasable attachment, through the use of a friction fit, press fit or luer lock, for example. The mixer 104 also has at least one outlet 108, and a source of at least a second component between the inlet 106 and the outlet 108. According to an exemplary embodiment, the second component may be thrombin.

The dispenser system 100 may be assembled as illustrated in FIGS. 1-4 by the manufacturer. Alternatively, the dispenser system 100 may be provided to the user in one or more pieces as a kit, the user assembling the pieces to define the dispenser system. The kit may include a source of at least a first component, and a mixer adapter having an inlet adapted to be coupled to the source of at least a first component and an outlet. This kit may be a disposable kit, such as a sterile disposable kit for medical applications. Furthermore, certain pieces of the dispenser system 100 (such as the mixer) may be provided to the user, and then the user may separately obtain the other pieces that are assembled to define the dispenser system 100. All such possibilities are within the scope of the present disclosure.

Returning then to the embodiment illustrated in FIGS. 1-4, in particular FIG. 2, the source 102 of the first component, as illustrated, may include a hollow cylinder 110 having an outlet port 112 at a first end 114 which is coupled to the inlet 106 of the mixer 104. The illustrated source 102 also includes a piston 116 disposed within the hollow cylinder 110. As will be recognized, the motion of the piston 116 within the hollow cylinder 110 causes the at least first component disposed in a bore 118 of the hollow cylinder 110 to be ejected from the cylinder 110. The piston 116 may be formed from, for example, a siliconized rubber or a silicon-free rubber. In the latter case, the piston 116 may be a flurocoated rubber piston, such as may be obtained from Daikyo Seiko, Ltd. of Tokyo, Japan.

Movement of the piston 116 within the cylinder 110 may be achieved through the use of a variety of different mechanisms. For example, as illustrated, a connecting rod, push rod or pusher 120 may be coupled at a first end 122 to the piston 116, and at a second end 124 to a thumb rest 126, such as may be found in a typical syringe. As illustrated, the second end 124 of the pusher 120 may be formed integrally with the thumb rest 126. The source 102 may also include finger loops 128 that are attached to the hollow cylinder 110 at a second end 130 of the hollow cylinder 110. The user may thus place his or her index and middle fingers through the finger loops 128 and his or her thumb on the thumb rest 126, and apply force to the pusher 120 and piston 116 as the thumb is advanced in the direction of the fingers to move the piston 116 in the cylinder 110.

However, the illustrated pusher 120/thumb rest 126/finger loops 128 arrangement is not the only mechanism by which the piston 116 may be advanced along the bore 118 of the hollow cylinder 110. For example, the source 102 may be disposed in an applicator apparatus that moves the piston 116 using mechanical, electro-mechanical, hydraulic, or pneumatic systems, which systems may in turn be actuated by mechanical, electro-mechanical, electrical, hydraulic or pneumatic actuators. It will be recognized that the mechanism used to move the piston 116 may be selected from any of combination of these options.

Similarly, the piston 116/cylinder 110 arrangement is not the only structure for containing a component and ejecting the component into the mixer 104. It will be recognized, for example, that the component could be stored in one structure, and then pumped from that structure into the mixer. According to such an embodiment, the volume of the space in which the first component is contained would not vary during operation, as it does in the piston 116/cylinder arrangement 110. Other variants would also be possible.

Turning now to the mixer 104, the mixer 104 includes a barrier 140, a mixing device 142, and a source 144 of at least a second component. As illustrated, the mixer 104 includes a hollow cylinder 146 that defines a passageway 148. The barrier 140 and the mixing device 142 are spaced from each other along the passageway 148 between the inlet 106 and the outlet 108 of the mixer 104 to define a volume 150 therebetween with the source 144 of at least a second component disposed in the volume 150.

According to certain embodiments of the present disclosure, where the distance between the barrier 140 and the mixing device 142 is 3 mm, the volume 150 may be approximately 18 μl. As a consequence, if a second component having a concentration of 100 IU/ml is disposed in the volume 150, then 1.8 IU of the second component may be immobilized between the barrier 140 and mixing device 142. Similarly, for concentrations of 1000 IU/ml and 10,000 IU/ml, 18 IU and 180 IU will be immobilized in the volume 150, respectively. This permits the amount of the second component present to be controlled according to the requirements of the user and the purpose of the application; for example, where the second component is a catalyst, the amount of the second component immobilized in the volume 150 may control the kinetic of polymerization.

According to the illustrated embodiment, the barrier 140 may be a mixing device similar to the mixing device 142. This is particularly useful where the mixer 104 may be provided to the user disassembled from the source 102, so that the user does not need to determine if the mixer 104 is assembled in the correct orientation relative to the source 102 so as to place a mixing device downstream from the source 144 of the second component. Alternatively, as described in greater detail below, two mixing devices may be required where the first and second components are passed from the source 102 through the mixer 104 into a holding container, and then returned from the holding container through the mixer 104 to the source 102. However, in applications where the mixer 104 is already assembled to the source 102 by the manufacturer or where the inlet 106 and outlet 108 of the mixer 104 are structured to permit only a single orientation of the mixer relative to the source 102 (e.g., male/female couplings), the barrier 140 may be fabricated of a material different than the mixing device 142. It will be recognized that the barrier 140 should still exhibit certain characteristics (such as porosity) to permit the first component to pass through into the volume 150 between the structures 140, 142.

Thus, at least the mixing device 142 may be defined by a three-dimensional lattice or matrix that defines a plurality of tortuous, interconnecting passages therethrough. The mixing device 142 may have physical characteristics to sufficiently mix the first and second components, which characteristics include a selected one or more of mean flow pore size, thickness and porosity. According to the illustrated embodiment, both the barrier 140 and the mixing device 142 have physical characteristics to sufficiently mix the first and second components, which characteristics include a selected one or more of mean flow pore size, thickness and porosity.

As a result of three-dimensional lattice structure with tortuous, interconnecting passages, the components are intimately mixed together as they pass through the mixer 104. The mixer 104 may provide for a laminar flow of the components to enhance mixing between the components. Alternatively, the mixer may provide other flow conditions which preferably promote significant mixing of the components.

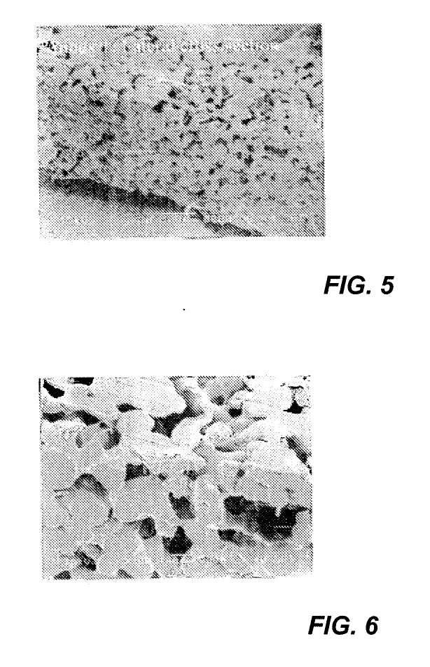

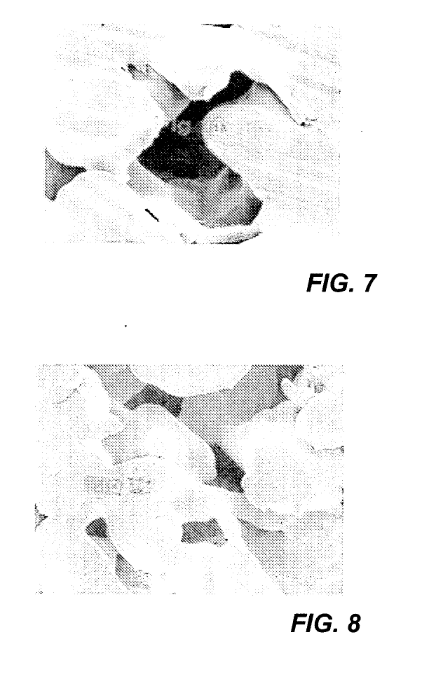

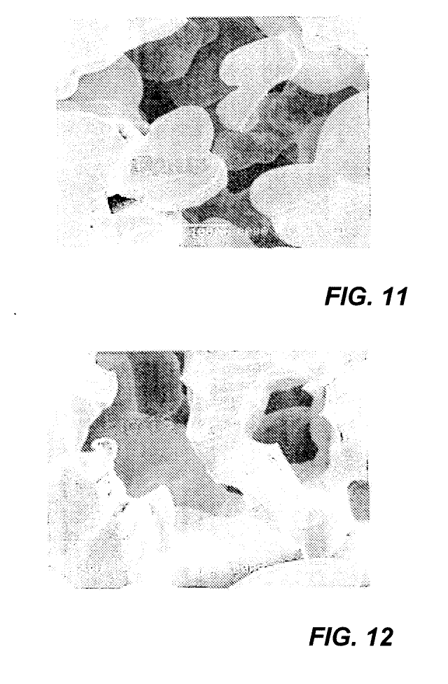

One preferred material for the mixing devices 140, 142 is illustrated in cross-sections in FIGS. 5-12. The material shown there is polymeric material formed by sintering to define an integral porous structure. The lattice or matrix of polymeric material forms a plurality of essentially randomly-shaped, tortuous interconnected passageways through the mixer. The material of the mixing devices 140, 142 may be selected, for example, from one or more of the following: Polyethylene (PE), High Density Polyethylene (HDPE), Polypropylene (PP), Ultra High Molecular Weight Polyethylene (UHMWPE), Nylon, Polytetra Fluoro Ethylene (PTFE), PVdF, Polyester, Cyclic Olefin Copolymer (COC), Thermoplastic Elastomers (TPE) including EVA, Polyethyl Ether Ketone (PEEK), polymer materials other than polyethylene or polypropylene or other similar materials. The mixing devices 140, 142 may also be made of a polymer material that contains an active powdered material such as carbon granules or calcium phosphate granules with absorbed molecules. Other types of materials are also possible. A sintered polypropylene material suitable for the present invention may be available from commercial sources, such as from Bio-Rad Laboratories, Richmond, Calif., United States; Porex Porous Products Group of Porex Manufacturing, Fairburn, Ga., United States; Porvair Technology, a Division of Porvair Filtration Group Ltd., of Wrexham, United Kingdom (such as Porvair Vyon Porvent, PPF or PPHP materials); or MicroPore Plastics, Inc., of 5357 Royal Woods, Parkway, Tucker, Ga. 30084, http://www.microporeplastics.com/.

As a further alternative, the mixing device may be defined by a three-dimensional lattice or matrix made of a polymer co-sintered with at least a second material. For example, the polymer (such as the VYON-F polypropylene material) may be co-sintered with silica, such as may be available from Porvair Technology of Wrexham, United Kingdom. According to such further embodiments, the silica may be blended with the polymeric material prior to co-sintering, or sintered on one or both sides of the mixing device. Additionally, others materials could be used instead of silica; for example, mineral materials such as hydroxyapatite, insoluble calcium phosphate, glass, and quartz may be used.

Other materials that may be sintered to define an integral porous structure may include glasses, ceramics, and metals. In regard to metals, materials such as bronze, stainless steel, nickel, titanium, and related alloys may be used. Particular examples may include stainless steels, such as 316L, 304L, 310, 347, and 430, nickel alloys, such as HASTELLOY C-276, C-22, X, N, B, and B2 (HASTELLOY being a registered trademark of Haynes International, Inc. of Kokomo, Ind.), INCONEL 600, 625, 690, MONEL 400 (INCONEL and MONEL being registered trademarks of Huntington Alloys Corp of Huntington, W. Va.), Nickel 200 and Alloy 20, and titanium. Sintered metal materials suitable for use in the mixers and mixing methods of the present disclosure may be available from commercial sources, such as from Porvair Technology, a Division of Porvair Filtration Group Ltd., of Wrexham, United Kingdom (including BRM bronze materials); and Mott Corporation, of Farmington, Conn. (including stainless steels, nickel alloys (HASTEALLOY, INCONEL, MONEL, Nickel 200, Alloy 20) and titanium).

It is also possible that the mixing devices 140, 142 may be made of one or more materials having one or more characteristics that may assist mixing of the component streams. By way of example and not limitation, the material may be hydrophilic, which is material that essentially absorbs or binds with water, hydrophobic, a material which is essentially incapable of dissolving in water, oleophobic, a material which is essentially resistance to absorption of oils and the like, and/or have other characteristics that may be desired to enhance mixing of the components.

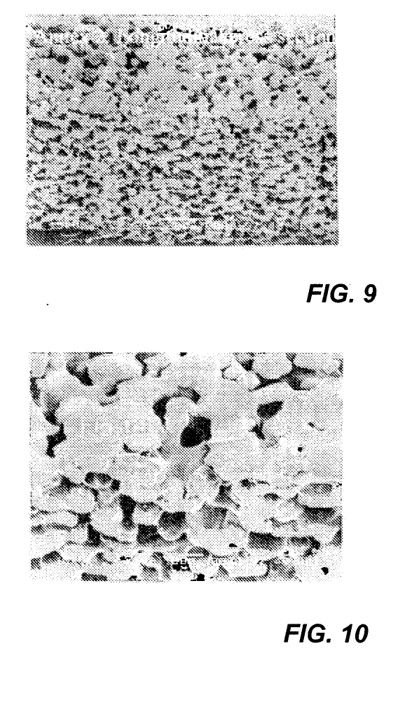

As noted above, the mixing devices 140, 142 are preferably defined, either in whole or in part, by a three-dimensional lattice or matrix that defines a plurality of tortuous, interconnecting passages therethrough. In FIGS. 5-12, the streams of the components may pass through the illustrated three-dimensional lattice or matrix that defines a plurality of tortuous, interconnecting passages so that the component streams are thoroughly mixed to create an essentially homogeneous combined fluid stream. At FIGS. 5-8, scanning electron pictures show lateral sections respectively at about ×30, ×100, ×350 and ×200 magnifications for a sintered polypropylene material having a width of approximately 8.0 millimeters (mm) and a thickness of about 1.0 mm. At FIGS. 9-12, scanning electron pictures show a longitudinal section respectively at about ×30, ×100, ×250 and ×350 magnifications for the same material shown in FIGS. 5-8, illustrating other views of the three-dimensional lattice. As shown in FIGS. 5-12, the illustrated passages preferably intersect at one or more random locations throughout the mixing devices 140, 142 such that the two component streams are randomly combined at such locations as such streams flow through the mixer. It should be understood that the three-dimensional lattice or matrix may be formed in a variety of ways and is not limited to the random structure of a sintered polymeric material as shown in FIGS. 5-12.

The illustrated mixing devices 140, 142 are made of a porous material and may have varying porosity depending on the application. Such porous material preferably has a porosity that allows the streams of the components to pass through to create a thoroughly-mixed combined fluid stream. The porosity of a material may be expressed as a percentage ratio of the void volume to the total volume of the material. The porosity of a material may be selected depending on several factors including but not limited to the material employed and its resistance to fluid flow (creation of excessive back pressure due to flow resistance should normally be avoided), the viscosity and other characteristics and number of mixing components employed, the quality of mixing that is desired, and the desired application and/or work surface. By way of example and not limitation, the porosity of a material that may be employed for mixing fibrin components may be between about 20% and 60%, preferably between about 20% to 50% and more preferably between about 20% and 40%.

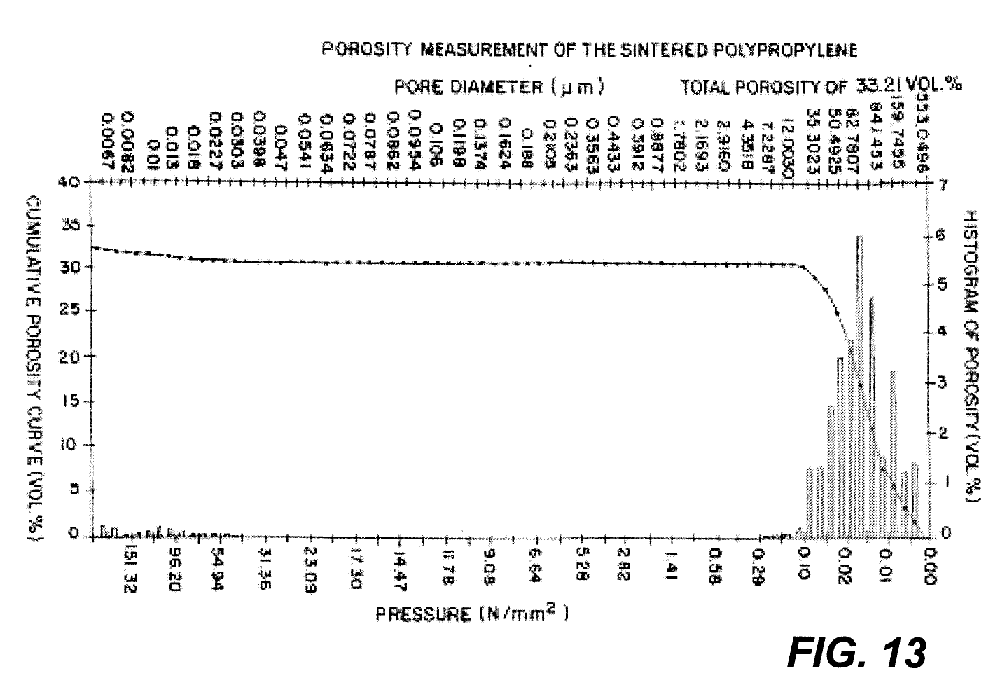

At FIG. 13, porosity measurements of a selected material, manufactured by Bio-Rad Laboratories, are shown as obtained using a mercury porosity test on an Autopore IIII apparatus, a product manufactured by Micromeritics of Norcross, Ga. It may also be possible to determine the porosity of a selected material in other ways or using other tests. At FIG. 13, such porosity measurements show the total volume of mercury intrusion into a material sample to provide a porosity of about 33%, an apparent density of about 0.66 and an average pore diameter of about 64.75 microns. Materials with other porosities also may be employed for mixing fibrin or for mixing combined fluid streams other than fibrin, as depending on the desired application.

Also, the mean pore size range of the mixing devices 140, 142 may vary. In the three-dimensional lattice shown in FIGS. 5-12, the mixing devices 140, 142 may define a plurality a pores that define at least a portion of the flow paths through which the streams of the components flow. The range of mean pore sizes may be selected to avoid undue resistance to fluid flow of such component streams. Further, the mean pore size range may vary depending on several factors including those discussed above relative to porosity.

Several mean pore size ranges for different materials that may be used in the mixing devices 140, 142 are shown in Table 1, except at no. 16 which includes a “control” example that lacks a mixer.

TABLE 1
PART III: Evaluation of single porous disks
Materials from Porvent and Porex

| | | | | Mean Pore | | | |
|---|---|---|---|---|---|---|---|
| Sample ID | Type | Form | Property | Size | | Thickness | Mixing |
| 2 | | PE sheet | Hydrophobic | 5-55 | μm | 2.0 mm | Good |
| 21 | | PP sheet | Hydrophobic | 15->300 | μm | 2.0 mm | Good |
| 6 | | PE sheet | Hydrophobic | 20-60 | μm | 3.0 mm | Good |
| 19 | | PP sheet | Hydrophobic | 70-210 | μm | 1.5 mm | Good |
| 22 | | PP sheet | Hydrophobic | 70-140 | μm | 3.0 mm | Good |
| 24 | | PP sheet | Hydrophobic | 125-175 | μm | 3.0 mm | Good |
| 1 | | | Hydrophobic | 7-12 | μm | 1.5 mm | no fibrin |
| | | | | | | | extrusion |
| 8 | | PE sheet | Hydrophobic | 40-90 | μm | 1.5 mm | Good |
| 7 | | PE sheet | Hydrophobic | 20-60 | μm | 1.5 mm | Good |
| 9 | | PE sheet | Hydrophobic | 20-60 | μm | 3.0 mm | Good |
| 16 | | PE sheet | Hydrophobic | 40-100 | μm | 1.5 mm | Good |
| 18 | | PE sheet | Hydrophobic | 40-100 | μm | 3.0 mm | Good |
| 20 | | PE sheet | Hydrophobic | 80-130 | μm | 3.0 mm | Good |
| 14 | | PE sheet | Hydrophobic | 20-60 | μm | 1.5 mm | Good |
| 17 | | PE sheet | Hydrophobic | 80-130 | μm | 1.5 mm | Good |
| 26 | Control | — | — | — | | — | — |
| 27 | | PP sheet | Hydrophobic | 7-145 | μm | 1.5 mm | Good |

Table 1 includes several commercial sintered polyethylene (PE) or polypropylene (PP) materials manufactured by Porex or by Porvair under the tradename Porvent or Vyon. The table summarizes the mixing results achieved from each material based on quality of fibrin obtained after fibrinogen and thrombin (4 International Units (IU)/ml) passed through a device having a single mixing device, except for one experiment (at ID 26) which is the control and lacks any mixer. The indicated mean pore size ranges vary between about 5 and 300 microns. In Table 1, the ranges for materials nos. 2, 21, 6, 19, 22, 24, 8-9, 16, 18, 20, 14, 17, and 27 each generally indicate good mixing quality for fibrin. In Table 1, such mean pore size ranges are not intended to be exhaustive and other mean pore size ranges are also possible and useful for mixing. The mean pore size ranges indicated in Table 1 were obtained from the technical data sheets of the listed materials provided by the suppliers Porvair and Porex.

The mixing device 140, 142 may be further configured and sized so as to provide sufficiently thorough mixing of the streams of the components. The size of the mixing device 140, 142 may vary depending on such factors which include the size and/or configuration of the dispenser 100, the type of material used for the mixing devices 140, 142, the porosity and mean pore size of the material used for the mixing devices 140, 142, the desired degree of mixing, the components to be mixed, and/or the desired application. For mixing devices 140, 142 having the above discussed example ranges for porosity and mean pore sizes, the thickness of the individual devices 140, 142 may range between about 1.5 mm and 3.0 mm, as indicated in Table 1. Other thicknesses are also possible, including a variable or non-uniform thickness.

Also, the shape and configuration of the mixing devices 140, 142 may vary from the generally circular cross section or disk shape that is shown. It is possible that the mixer may have other shapes or configurations including but not limited to elliptical, oblong, quadrilateral or other shapes. In the embodiment shown, the mixer radius may range between about 3 mm and 5 mm although other dimensions are also possible.

Also, the mixing devices 140, 142 may be manufactured in various ways which may depend on the desired shape, thickness and/or other characteristics of the material or materials that is employed for the mixing devices 140, 142. By way of example and not limitation, the mixing devices 140, 142 may be fabricated or sectioned from one or more pieces of material having a desired size, thickness and/or other characteristics for the mixing devices 140, 142. Alternatively, the mixing devices 140, 142 may be prefabricated including one or more molding processes to form a mixing devices 140, 142 having a desired size, thickness and/or other characteristics. It is also possible that the mixing devices 140, 142 may be manufactured in other ways.

The material for the mixer may be characterized and selected for a given application based on one or more physical characteristics so as to provide a sufficiently and relatively homogeneous combined fluid stream downstream of the mixer and upon passing the component streams through the mixer. By way of example, Table 2 illustrates various sintered polymer materials for the mixers suitable for use in the dispensers systems and methods described herein, and their physical characteristics. The specific materials identified in Table 2 are manufactured by, for example, Porvair Filtration Group Ltd. (Hampshire, United Kingdom) or Porex Corporation (Fairburn, Ga., USA). The data represented in this table includes the K value from Darcy's Law, which may be obtained from the following equation:

K=Q*η*L/(S*ΔP)

where Q is the Flow rate of fluid flow through the material;

S is the surface area of the material;

ΔP is the change in pressure between the upstream and downstream locations of the material;

L is the thickness of the material; and

η is the viscosity of the fluid flowing through the material, or if more than one fluid is flowing the viscosity of the more viscous component.

The K values typically represent a permeability value and are represented in Table 2 based on increasing K value, expressed in units of μm²s which represents increasing values of permeability. Table 2 also summarizes several physical characteristics of the material including the relative values for minimum pore size (min.) mean flow pore size, maximum pore size (max.), average bubble point (or pressure that causes the liquid to create air bubbles), thickness, and porosity. The physical characteristics of each of the materials in Table 2 were obtained based on testing using methods known to those of skill in the art.

By way of example and not limitation, the K values in Table 2 were obtained by permeability testing using water passed through the listed materials having the indicated physical characteristics. The permeability test was helpful to characterize materials based on their K value, and these materials are listed in order of increasing K value in Table 2. For the measurement of permeability, the materials employed included sintered porous material sheet supplied by Porvair and Porex. The permeability test was performed on a syringe that was filled with water. The pressure reducer was turned off and all connections downstream of the syringe were opened. Then water was allowed to flow through the syringe until the pressure drop between top and bottom of the syringe was about zero. The pressure reducer was then switched on and compressed air was injected to push water from the syringe at a constant flow rate. The volume of injected air was determined based on monitoring the flow of water between upper and lower volumetric markings on the syringe. As soon as the water meniscus crossed the upper mark, the time and pressure were recorded (P1). When the water meniscus crossed the lower mark on the syringe body, the total time (t), pressure (P2) and volume of water (V) were recorded. In addition to the known values of P1, P2, t and V, the remaining parameters for the calculation of permeability that were known include: Diameter of sintered material disc is about 10 mm, the thickness is about 1.5 mm, the surface of sintered material disc is about 78.54 mm2, the Dynamic viscosity of water 10-3 Pascal second (Pa·s). This test was used to determine the K values in Table 2.

As described herein, it is contemplated that other liquids, gases and solids may be used to determine a K value from Darcy's Law for these materials or other materials. It is realized that different liquids, gases and solids will change the viscosity value (η) of Darcy's Law and, as such, will provide different K values or ranges for a given set of physical properties (thickness L and surface area S) of the material, flow rate Q and pressure difference ΔP that may be employed. Further, even where the same liquid, gas or solid is used, such that the viscosity is held constant, other parameters may be varied to achieve different K values. By way of example and not limitation, any one or more of the flow rate, surface area, thickness, and/or pressure difference may be varied and, as such, vary the resulting K value that is determined.

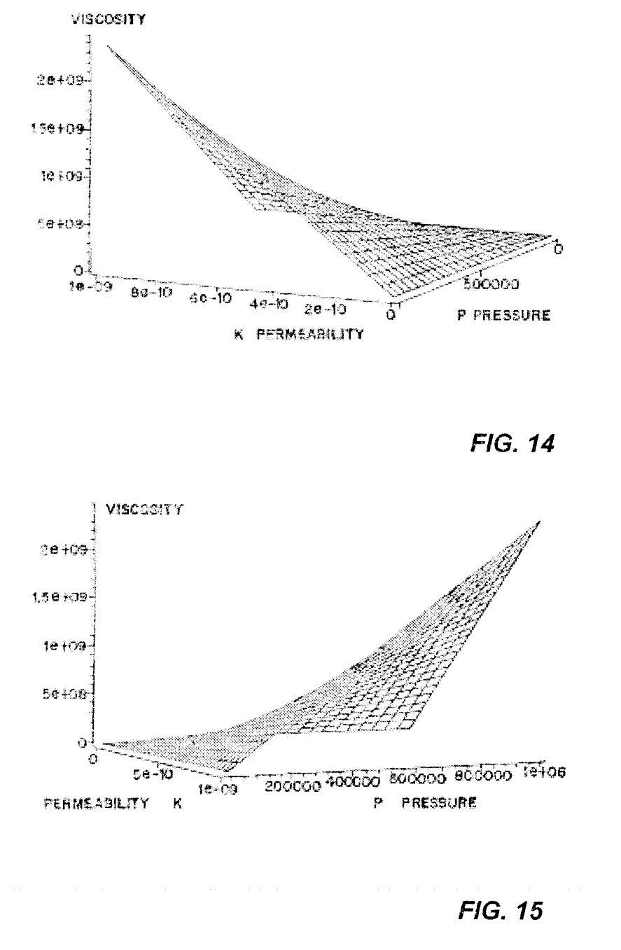

Turning briefly to FIGS. 14-15, a three-dimensional curve shows the permeability or K values along one axis, pressure values along a second axis and viscosity values along a third axis (with FIG. 15 identical to FIG. 14, except the axes of permeability and pressure have been rotated clockwise to better show the curve). Generally speaking, the illustrated curve is applicable to any liquid, gas or solid that may be employed for permeability testing of a given material. By way of example, FIGS. 14-15 show the variation in permeability or K values, pressure values and viscosity, assuming other parameters of Darcy's Law, such as surface area S, flow rate Q and material thickness L are held constant. As indicated in FIGS. 14-15, for a given viscosity and pressure value, the permeability or K value may known according to the illustrated curve. Even if only one of the permeability, pressure or viscosity value is constant, the curve provides an indication of the other two values, which may vary along the illustrated curve, due to their relationship to each other based on Darcy's Law, described above.

TABLE 2

| | | Porosity | | | | | |
|---|---|---|---|---|---|---|---|
| Permeability | | | Mean Flow | | | | |
| Sample | K “μm” | Min. | Pore | Max | Avg. Bubble Pt. | Thick | Porosity |
| 1 | 0.55 | 3 | 5 | 7 | 13 | 1.5 | 45 |
| 2 | 1.41 | 4.0-7.0 | 17-22 | 50-60 | 50-70 | 2 | 27 |
| 3 | 1.93 | 5.0-8.0 | 8.0-12 | 12.0-18.0 | 15-25 | 2 | 44 |
| 4 | 3.41 | 4.0-7.0 | 17-22 | 50-60 | 50-70 | 2 | 27 |
| 5 | 3.76 | 4.0-7.0 | 17-22 | 50-60 | 50-70 | 2 | 27 |
| 6 | 4.72 | 6 | 16 | 36 | 47 | 3 | 42 |
| 7 | 5.08 | 9 | 23 | 49 | 57 | 1.5 | 48 |
| 8 | 5.81 | 10 | 36 | 88 | 101 | 1.5 | 39 |
| 9 | 6.18 | 7 | 21 | 45 | 52 | 3 | 45 |
| 10 | 6.48 | 6.0-9.0 | 35-45 | 130-160 | 101-130 | 1.5 | 39 |
| 11 | 6.55 | 6.0-9.0 | 35-45 | 130-160 | 101-130 | 1.5 | 39 |
| 12 | 6.67 | 7.0-11 | 30-40 | 85-105 | 60-80 | 1.68 | 39 |
| 13 | 7.14 | 6.0-9.0 | 35-45 | 130-160 | 101-130 | 1.5 | 39 |
| 14 | 7.14 | 9 | 28 | 64 | 67 | 1.5 | 49 |
| 15 | 7.32 | 7.0-11 | 25-35 | 68-88 | 55-75 | 2 | 35 |
| 16 | 7.89 | 14 | 43 | 119 | 108 | 1.5 | 51 |
| 17 | 10.90 | 13 | 65 | 300 | 183 | 1.5 | 56 |
| 18 | 10.99 | 9 | 32 | 70 | 85 | 3 | 46 |
| 19 | 12.30 | 11 | 80 | 300 | 207 | 1.5 | 50 |
| 20 | 12.57 | 10 | 51 | 140 | 129 | 3 | 48 |
| 21 | 14.09 | 13-17 | 80-100 | 300 | 180-210 | 2 | 51 |
| 22 | 15.02 | 10 | 61 | 217 | 163 | 3 | 46 |
| 23 | 15.64 | | | | | | |
| 24 | 16.49 | 12 | 81 | 300 | 227 | 1.5 | 42 |
| 25 | 25.23 | 15 | 298 | 300 | TP | 3 | 49 |

TABLE 3

| Sample | MFP * thick * PV * 1000 | K |
|---|---|---|
| 1 | 3.375 | 0.55 |
| 3 | 8.8 | 1.93 |
| 2 | 10.53 | 1.41 |
| 4 | 10.53 | 3.41 |
| 5 | 10.53 | 3.76 |
| 7 | 16.56 | 5.08 |
| 6 | 20.16 | 4.72 |
| 14 | 20.58 | 7.14 |
| 15 | 21 | 7.32 |
| 8 | 21.06 | 5.81 |
| 12 | 22.932 | 6.67 |
| 10 | 23.4 | 6.48 |
| 11 | 23.4 | 6.55 |
| 13 | 23.4 | 7.14 |
| 9 | 28.35 | 6.18 |
| 16 | 32.895 | 7.89 |
| 18 | 44.16 | 10.99 |
| 24 | 51.03 | 16.49 |
| 17 | 54.6 | 10.9 |
| 19 | 60 | 12.3 |
| 20 | 73.44 | 12.57 |
| 22 | 84.18 | 15.02 |
| 21 | 91.8 | 14.09 |
| 25 | 438.06 | 25.23 |

At Table 3, the K values of the materials listed at Table are represented. By way of example and not limitation, good, homogeneous mixing of a combined fibrinogen and thrombin mixture has been observed using mixer or disk made of a material having a K value from Tables 2-3 between approximately 5 and 17. In addition, Table 3 includes a numerical product of the mean flow pore size (MFP), thickness and porosity volume (PV) multiplied by 1000 (based on increasing value of this product). It has also been observed that using a mixer having a MFP*thickness*PV*1000 value, within the range of about 16 to 438 achieves good, homogeneous mixing of fibrin. The mixer material may also be selected based on one or more of the above physical characteristics or other characteristics. As discussed above, the permeability or K values may vary from those discussed above in Tables 2-3, for example, where a liquid other than water is used, or where a gas and solid may be employed for the permeability testing or where different physical characteristics or parameters are employed. In such instances, it is contemplated that an appropriate range of K values will be determined and the material of the mixer may be appropriately selected based on a range of K values that is determined to provide sufficient quality of mixing. Also the K values may differ due to the technique utilized in measuring the value.

Additionally, three commercial sintered bronze materials manufactured by Porvair under the tradename BRM have been tested using methods known to those of skill in the art to develop physical characteristic data similar to that presented in Tables 2 and 3. Bronze materials are believed to be better suited for higher flow rate (for example, on the order of one liter/second), higher pressure (for example, in excess of 1 Bar) applications. BRM 30 has a range of pore sizes from 9 μm to 135 μm, BRM 40 has a range of pore sizes from 12 μm to 300 μm, and BRM 60 has a range of pore sizes from 20 μm to above 300 μm. The mean flow pore sizes are 38 μm, 58 μm, and 100 μm for the BRM 30, BRM 40, and BRM 60 materials, respectively. Furthermore, the K values for these materials were 26.99, 46.19, and 65.94 for the BRM 30, BRM 40 and BRM 60 materials, respectively.

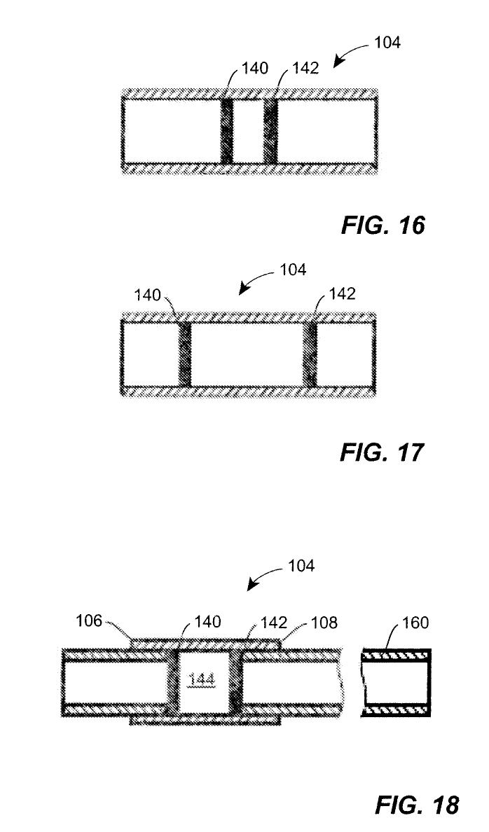

The mixing devices 140, 142 may be preassembled as part of a mixer 104, as illustrated, such as by molding ultrasonic welding, mechanical fittings or other attachment techniques within a housing, which is defined in FIGS. 1-4 by the hollow cylinder 146. As seen in FIGS. 2 and 3, the mixing devices 140, 142 may be held in place without mechanical fittings. As illustrated in FIGS. 16 and 17, the mixing devices 140, 142 may be positioned closer to each other or farther away from each other than illustrated in FIGS. 1-4.

As illustrated in FIG. 18, the dispenser system 100 may feature one or more additional devices coupled to the outlet 108 of the mixer 104. For example, the dispenser system may include a cannula 160 coupled to the outlet 108 of the mixer 104. Other alternatives may include tubes or tubing segments, needles, luer tips, catheter, spray tips or spray devices, depending on the desired form in which the combined mixture is to be applied and/or the work surface. These additional devices may be coupled as a permanent attachment, through the use of an adhesive for example, or a releasable attachment, through the use of a friction fit, press fit or luer lock, for example.

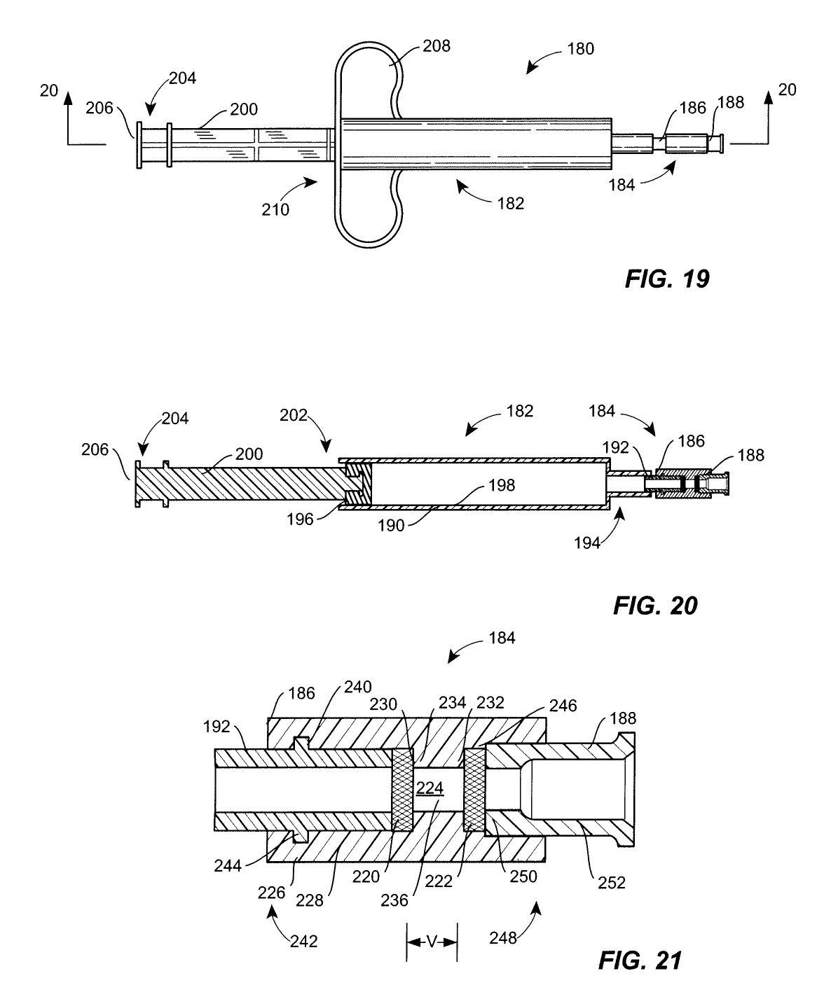

FIGS. 19-22 illustrate an alternative dispenser system 180, which may be provided to the user as a kit. Similar to the dispenser system 100, the dispenser system 180 includes a source 182 of at least a first component and a mixer 184, although the source 182 and the mixer (or mixer adapter) 184 may be provided to the user, sterile and double-packed in soft or rigid blisters, separate from each other, rather than assembled together. An inlet 186 of the mixer 184 is attached to the source 182, and has a source of at least a second component disposed between the inlet 186 and an outlet 188. Further, as seen in FIG. 20, the source 182 includes a hollow cylinder 190 with an outlet port 192 located at a first end 194, and a piston 196 disposed within a bore 198 of the cylinder 190. Also similar to the source 102, a pusher 200 is attached to the piston 196 at a first end 202, and is attached (e.g., formed integrally with) at a second end 204 to a thumb rest 206. Finger loops 208 are also provided at a second end 210 of the cylinder 190 (see FIG. 19).

While the mixer 184 includes first and second mixing devices 220, 222 and a source 224 disposed between the mixing devices 220, 222, the mixer 184 has certain differences relative to the mixer 104.

For example, the mixer 184 includes a mechanical fitting to maintain the spacing between the first and second mixing devices 220, 222, as best seen in FIG. 21. According to the embodiment illustrated in FIG. 21, the mixer 184 includes a hollow cylinder 226 with a wall 228 having internal shoulders 230, 232 that define a section 234 of the wall 228 therebetween. The section 234 of wall 228 may be referred to as a spacer, and may provide a structure that maintains the spacing between the mixing devices 220, 222 to define a volume 236 in which the source 224 is disposed.

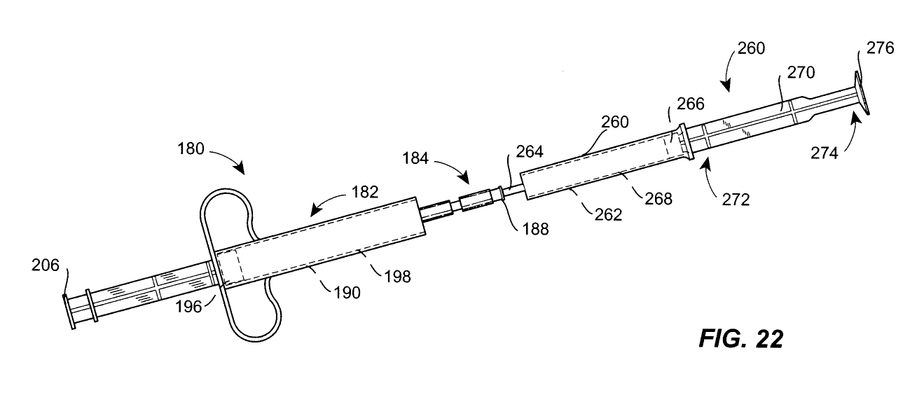

Further, the wall 228 may have a helical groove or grooves 240 at a first end 242, which groove or grooves 240 may cooperates with a projection or projections 244 disposed about the outlet port 192 of the source 182 to provide a luer-lock type connection. The wall 228 may also have a shoulder 246 at a second end 248 against which is disposed a first end 250 of a female luer tip 252. Thus, the mixer 184 permits releasable attachment at the first end 242 with the source 182, and at a second end 248 with a container 260, as best seen in FIG. 22.

As seen in FIG. 22, the container 260 includes a hollow cylinder 262 having a port 264 coupled to the outlet 188 of the mixer 184 and a piston 266 disposed within the hollow cylinder 262 (in the bore 268, in particular). Similar to the source 182, the container 260 also includes a pusher (which may also be referred to as a plunger) 270 coupled at a first end 272 to the piston 266 and at a second end 274 to a thumb rest 276. Depending upon its use, the container 260 may be referred to as a source (in that a component may be retained in the container 260 for combination with the first and second components), as a holding container (in that the mixture of the first and second components may be held in the container 260 for later application), as a transfer container (in that the mixture may be transferred into and out of the container, as explained below), or by a combination of these designations.

For example, the container 260 may be used as a source and as a transfer container in the following fashion. The source 182 may include a solution of fibrinogen, while the source 224 may include freeze-dried thrombin. The container 260 may contain air to be mixed with the product of the fibrinogen and thrombin, to create a “fibrin mousse”: i.e., a fibrin mixture having a relatively higher volume of air (such as 125% by air volume) and a lower density than fibrin mixed without air. The fibrin mousse may, for example, allow application to the underside of a patient's body, such as for treatment of acute or chronic injuries such as a foot ulcer injury. Other volumes of fibrinogen and thrombin, and having different relative amounts, may be combined with different volumes of air to increase or decrease the percentage of air contained in the combined fibrin mixture. The fibrin mousse obtained may also be spray dried to form fully or partially polymerized beads, lyophilized to form a sponge or grinded to obtain a hemaostatic powder (dry fibrin glue), as described in U.S. Pat. No. 7,135,027, as incorporated herein by reference.

In use, the piston 196 of the source 182 may be advanced within the cylinder 190 to eject fibrinogen into the mixer 184. The fibrinogen passes through the first mixing device 220 and into the volume 236 in which the thrombin is disposed so as to mix with the thrombin. The product of this mixing then passes through the second mixing device 222 and into the container 260 through the port 264, where it mixes with the air already in the container 260. The piston 266 is then advanced within the container 260 to eject the mixture from the container 260 into the mixer 184 and back into the source 182. This “swooshing” process between the source 182 and the container 260 may be repeated several times before the fibrin foam is determined by the user to be ready for application.

It should be noted that testing utilizing a system such as is shown in FIG. 22 has suggested that the number of transfers between the dispensers or containers does not have a significant impact on the diameter of the bubbles formed when mixing fibrinogen or thrombin with air to produce a foam. On the other hand, it is believed that the type of material utilized for the mixer (relative to its K value) and the air fraction influence the diameter of the bubble formed. That is, once the material has been transferred four times between the containers using a mixing device made of VYON-F material, a homogenous foam with an average bubble diameter of approximately 50 μm is formed, and additional transfers do not change the diameter or the size dispersion (normalized fluctuation of the average bubble diameter) appreciably. On the other hand, increasing the air fraction from 50% to 70% may increase the average bubble diameter from approximately 50 μm to approximately 65 μm, as may changing the material used as the mixer. It is further believed that the results of testing using fibrinogen are applicable to fibrin as well.

It will be noticed that the mixture of fibrinogen, thrombin and air will pass through the mixer 184 between the spaces on either side of the mixing devices 220, 222 and the volume 236 between the mixing devices 220, 222. Using such a method of mixing, the spacing or distance (designated as “V” in FIG. 21) between the mixing devices 220, 222 may permit an enhanced mixing to occur. Generally speaking, it has been found that the presence of fibrin between the two mixers increases when the distance V between them increases. A distance V of about 3 mm and above may result in good fibrin formation to form a combination having sufficient homogeneity if the two mixing devices are within the size ranges discussed above. However, it will be recognized that the value V may also vary based on different designs and/or the different parameters that are employed in such design and so the value V is not limited to the above discussed values or ranges.

This process of mixing and a system for carrying out such a process may described as a “Stop and Go” process or system, in that the flow of fluid component streams are intermittently started and stopped. For such “Stop and Go” device the distance V preferably should not generate significant fibrin formation on the mixing devices or between the mixing devices. For a “Stop and Go” system employing at least two mixers, the distance V may vary. By way of example and not limitation, for a two mixer device, a distance V of about 4 mm may achieve sufficiently thorough mixing as well as avoid significant generation of fibrin on or between the two mixing devices.

It should also be noted that the mixing devices do not have to have the same characteristics, such as porosity, mean pore size or length to provide a beneficial effect. In fact, it may be desirable to varying the characteristics of the mixing devices to increase the thoroughness of mixing as the fluid streams pass through the dispenser. As well, introducing additional mixing devices spaced from the mixing devices 220, 222 may provide for additional opportunities to “Stop and Go” even if the spaces between these additional mixing devices are not used to retain components (e.g., thrombin) therebetween.

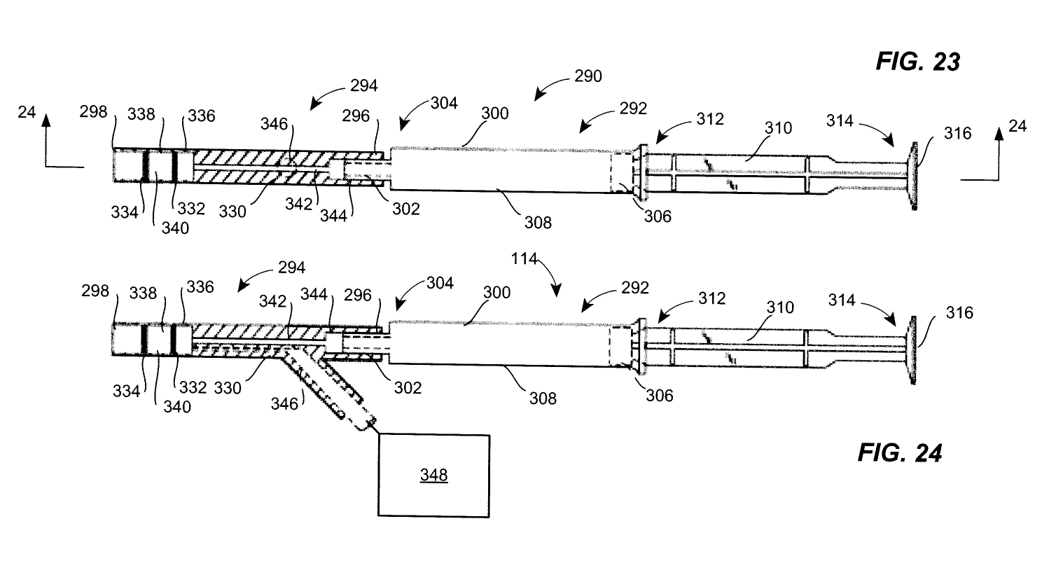

It will be recognized that other dispenser systems are possible for forming a fibrin mousse, other than the dispenser system described in FIGS. 19-22. One such alternative dispenser system 290 is illustrated in FIGS. 23 and 24.

As with the other systems discussed above, the system 290 includes a source 292 and a mixer 294. The mixer 294 has an inlet 296 and an outlet 298, and the inlet 296 of the mixer 294 is attached to the source 292. Further, the source 292 includes a hollow cylinder 300 with an outlet 302 disposed at a first end 304 of the cylinder 300. A moveable piston 306 is disposed in the cylinder 300, and in particular within a bore 308 of the cylinder, and is attached to a pusher 310 at its first end 312. The pusher 310 is attached at a second end 314 to a thumb rest 316.

According to this embodiment, the mixer 294 is defined by a block 330 having multiple passageways. First and second mixing devices 332, 334 are disposed in a first passageway 336 spaced from each other to define a volume 338 in which a source 340 of at least a second component is disposed. As noted above, the first mixing device 332 need not be made of the same material as the mixing device 334, and may instead be made of a material that retains the at least second component between the structures 332, 334 while not necessarily providing the mixing features discussed above. The passageway 336 is in fluid communication with the outlet 302 of the cylinder 300 via a narrower passageway 342 that also is in communication with a female coupling 344 that receives the outlet 302.

The mixer 294 also includes a second passageway 346 in communication with the first passageway 336 upstream of the first mixing device 332. This passageway 346 is also in fluid communication with a source 348 of sterile gas, such as air. The source of gas may be actuated by pneumatic, mechanical, electrical and/or some combination thereof, such as described and shown in U.S. patent application Ser. No. 11/331,243, filed Jan. 12, 2006, which is incorporated herein by reference. Thus, a mixed gas and component fluid stream may be provided from the outlet 298 of the mixer 294 (and thus the dispenser system 290).

It will be recognized that while the passageway 346 is disposed upstream of the first mixing device 332, it is also possible for the passageway 346 to introduce gas or water downstream of the mixing devices 332, 334. This alternative arrangement may be used to clean the passageways of the mixer 294 and/or the outlet 298 and/or other tubing or cannula structures located downstream. Cleaning of these structures may facilitate operation of a “Stop and Go” device during intermittent starting and stopping of fluid flow. It will be further recognized that additional, alternative orientations for the component passageways are also possible, such that the passageways are not limited to the orientations shown in FIGS. 23 and 24.

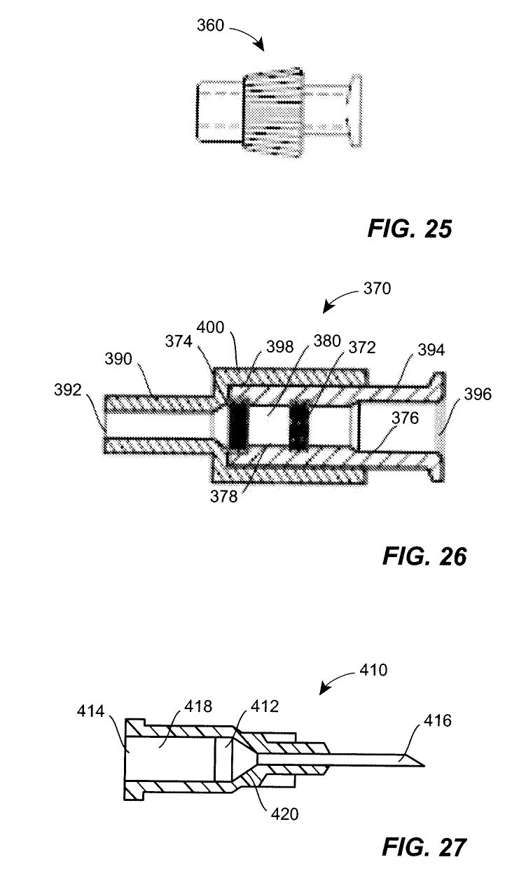

In addition, attachments may be introduced to the end of the dispenser systems 180, 290 to modify the consistency of the material exiting the outlet 188, 298 of the mixer 184, 294. One such attachment 360 is illustrated in FIG. 25. The attachment 360, which may be referred to as a spray head, may include a mechanical break up unit (or MBU), such as is shown and described in U.S. Pat. No. 6,835,186, which is incorporated by reference herein.

As noted above, it will be recognized that the mixer may be made available to the user separate from the other elements of the dispenser system, such as the source 102, 182, 292. The mixer, which may be referred to as a mixer adapter, may be designed to fit onto the end of a outlet of a source, by providing a female coupling to receive the male outlet of the source, for example. Otherwise, the mixer adapter would be similar to the mixer discussed above, and could be defined according to any of the mixers described above.

A further example of a mixer adapter 370 is illustrated in FIG. 26. The adapter 370 may include a first mixing device (or a barrier) 372 and a second mixing device 374. Each of the first and second mixing devices 372, 374 may be defined by a three-dimensional lattice defining a plurality of tortuous, interconnecting passages therethrough. The first and second mixing devices 372, 374 may be spaced from each other along a passageway 376 between an inlet and an outlet of the adapter 370 to define a volume 378 therebetween with the source 380 of at least a second component disposed in the volume 378. Further, at least the second mixing device 374 has physical characteristics to sufficiently mix the first and second components, which characteristics include a selected one or more of mean flow pore size, thickness and porosity.

In the illustrated embodiment, the mixer adapter 370 may include a male luer connector 390 defining one of the inlet and the outlet (as designated 392) and a female luer connector 394 defining the other of the inlet and the outlet (as designated 396). As illustrated, the female luer connector 394 defines the passageway 376 in which the mixing devices 372, 374 are disposed. Moreover, an end 398 of the female luer connector 394 is received within an end 400 of the male luer connector 390. The male and female luer connectors 390, 394 may be attached together, for example, by mechanical connection or by ultrasonic welding. While not illustrated, the male connector 390 may be combined with a luer-lock feature where employed in medical applications, although this need not be the case for every such application.

Having thus discussed the structural aspects of the dispensing system according to the present disclosure, focus turns to the components included in the sources. As mentioned above, one conventional tissue sealant is formed by mixing fibrinogen and thrombin to form fibrin. Fibrinogen is used as the substrate, while thrombin is used as the catalyst, cleaving fibrinopeptides A and B to form a fibrin network. While the conventional method uses equal volumes of fibrinogen and thrombin, the catalyst (thrombin) need only be present at low concentrations. Thus, using equal volumes has its drawbacks, in terms of the number of steps required to reconstitute the components to perform the method, and in terms of the relative viscosities of the components once reconstituted.

Experiments have been performed using devices similar to those described above, wherein freeze-dried thrombin has been introduced into a volume defined between two mixing devices made of VYON F. In particular, mixers were prepared using 200 μL of a solution of thrombin having a concentration of 500 IU/mL freeze-dried between the mixing devices. These mixers were used with a syringe-type source containing either 0.5 or 1.0 ml of fibrinogen. In all experiments, the fibrin product provided acceptable results: The material flowed freely from the dispenser system in the first set of experiments, and polymerization occurred either in about 30 minutes to 1 hour.

According to still further embodiments, the at least second component may be immobilized within the mixing device itself, instead between a barrier and a mixing device, or between two mixing devices. For example, an embodiment of an catheter-type attachment 410 is illustrated in FIG. 27, which attachment 410 may be secured to a luer of a syringe, such as illustrated in FIG. 1. This attachment 410 has a single mixing device 412 in which at least a second component has been immobilized, at least a first component being disposed in the syringe connected to the attachment 410 according to this exemplary embodiment. The mixing device 412 thus becomes the second source.

In particular, the attachment 410 has a first end 414 sized to receive a luer of a syringe, for example, therein. The attachment 410 also has a second end 416 through which the mixture of the at least first and second components may exit. A passage 418 extends between the first and second ends 414, 416, with the mixing device 412 disposed in the passage 418 abutting a sloping shoulder 420. The passage 418 narrows from a first cross-section area at the first end 414 to a second cross-section area at the second end 416 in the region of the sloping shoulder 420. It will be recognized that according to other embodiments, the mixing device 412 may be disposed within the section of the passage 418 of the second cross-sectional area.

According to this exemplary embodiment, the second component may be immobilized by freeze-drying the second component within the porous structure of the mixing device 412. To prepare the mixing device 412, a solution of the second component may be passed through the mixing device 412. The mixing device 412 is freeze-dried with the second component in place within the porous structure of the mixing device 412.

For example, where the pore volume (or porosity) is known, as shown above in Table 2, a rough approximation may be made for the amount of second component present in the mixing device 412. Assuming a mixing device 412 having a diameter of 3.8 mm, a thickness of 1.5 mm, and a porosity of 45%, the void volume that may be filled with the second component is 7.65 μl. Again, the amount of second component immobilized will be dependent upon the concentration of the solution used, but for a solution with a concentration of 100 IU/ml, 0.7 U of the second component may be immobilized in the mixing device 412.

In the alternative, the second component may be immobilized by adsorption of the second component on the surface of the porous structure of the mixing device 412. Adsorption may provide additional advantages in that the volume of the diluent of thrombin used may permit a doubling of the volume of the diluent of fibrinogen used, leading to a reduction in the viscosity of the fibrinogen. Given that the dilution/viscosity curve is non-linear, the doubling of the volume of diluent may lead to a viscosity of between 5 and 20 cps (centipoise). While such an alternative may be use a mixing device made of a single material, the mixing device may be made of co-sintered materials; it is believed that materials may be selected to increase adsorption on the surface of the mixing device over a mixing device using a single material.

For example, it has been shown experimentally that thrombin may be adsorbed on the surface of a porous structure made of the VYON-F material described above. In particular, a thrombin at a concentration of 500 IU/ml was diluted with a carbonate/bicarbonate buffer (pH 9.0) to obtain thrombin at a concentration of 250 UI/ml. The mixing device 412 made of the VYON-F material was placed in 50 μl of the thrombin for 10 minutes, and then the mixing device 412 was washed with distilled water. It is believed that the washing with distilled water will cause any thrombin not adsorbed to the surface of the mixing device 412 to be removed.

As confirmation of the fact that thrombin was adsorbed to the surface of the mixing device 412 as a consequence of this process, 100 μl of a synthetic substrate, SQ150, at a concentration of 1.4 μmole/ml (0.85 m/ml) was added. The substrate couples to paranitroaniline, permitting optical density readings at wavelengths of approximately 400 nm. Based on these readings, it has been estimated that 2.2 IU was adsorbed to the disc. It is believed that additional thrombin could be adsorbed with an increase in the specific surface of the mixing device 412. It is also believed that different materials may permit an increase in the adsorption of the thrombin, and that the thrombin may be adsorbed to the material of the cannula in which the mixing device 412 is disposed, if the adsorption process is carried out with the mixing device 412 already in place as illustrated in FIG. 27.

It will be recognized that the attachment 410 provides a certain level of disposability in common with certain of the devices described above. That is, if the attachment 410 becomes clogged, the attachment 410 may simply be disconnected from the source of the first component, such as a syringe, and a new attachment 410 may be connected. The replacement of the attachment 410 may not only serve to correct the clogging issue, but also to provide a new dose of the second component.

While the embodiment wherein the second component (e.g., thrombin) is immobilized in the mixing device 412 has been described with respect to a cannula-type attachment, it will be recognized that the mixing device 412 could have been used in place of any of the mixers described with respect to FIGS. 1-26. As such, the mixing device with component immobilized therein may be used in a mixer securely attached to a source of another component, such as a syringe. According to another variant, the mixing device may be used in a mixer disposed between a source of another component and a source of air, with the mixture of the first and second components and the air being swooshed back and forth through the mixing device. Other variants will also be recognized with reference to the embodiments illustrated in FIGS. 1-26 and discussed above.

Variants are also possible relative to the components contained in the first and second sources. For example, the first source 102, 182, 292 may include at least a first component (e.g., fibrinogen), as noted above. However, the source 102, 182, 292 may also include a first component and another component. Similarly, the source 144, 224, 244 may include at least a second component (e.g., thrombin), as noted above. However, the source may also include a second component and a further component.

For example, it is also possible to introduce other additive agents, such as antibiotics, drugs or hormones to one or more of the sources. For example, additives such as Platelet Derived Growth Factor (PDGF) or Parathyroid Hormone (PTH), such as those manufactured for Kuros Biosurgery AG of Zurich, Switzerland, may be added to one of the fibrin-forming components, such as the fibrinogen. Bone morphogenic proteins (BMP) may also be employed. By way of example and not limitation, other agents include hydroxypropylmethylcellulose, carboxylmethylcellulose, chitosan, photo-sensitive inhibitors of thrombin and thrombin-like molecules , coagulation factors activated or not, as VII, X prothrombin, VIIIc antibodies, Trypsin type III, self assembling amphiphile peptides designed to mimic aggregated collagen fibers (extracellular matrices), catalyst, pro-catalysts, PEG's factor XIII, cross-linking agents, pigments, fibers, polymers, copolymers, antibody, antimicrobial agent, agents for improving the biocompatibility of the structure, proteins, anticoagulants, anti-inflammatory compounds, compounds reducing graft rejection, living cells, cell growth inhibitors, agents stimulating endothelial cells, antibiotics, antiseptics, analgesics, antineoplastics, polypeptides, protease inhibitors, vitamins, cytokine, cytotoxins, minerals, interferons, hormones, polysaccharides, genetic materials, proteins promoting or stimulating the growth and/or attachment of endothelial cells on the cross-linked fibrin, growth factors, growth factors for heparin bond, substances against cholesterol, pain killers, collagen, osteoblasts, drugs, etc. and mixtures thereof. Further examples of such agents also include, but are not limited to, antimicrobial compositions, including antibiotics, such as tetracycline, ciprofloxacin, and the like; antimycogenic compositions; antivirals, such as gangcyclovir, zidovudine, amantidine, vidarabine, ribaravin, trifluridine, acyclovir, dideoxyuridine, and the like, as well as antibodies to viral components or gene products; antifungals, such as diflucan, ketaconizole, nystatin, and the like; and antiparasitic agents, such as pentamidine, and the like. Other agents may further include anti-inflammatory agents, such as alpha- or beta- or .gamma-interferon, alpha- or beta-tumor necrosis factor, and the like, and interleukins.

Other additives may be introduced into one or more of the components as well. For example, catalysts, co-catalysts, visualization agents, dyes, markers, tracers, and disinfectants may be included. Particular examples of suitable visualization agents are described in U.S. Pat. Nos. 6,887,974 and 7,211,651, while examples of dyes (e.g., squaraine dyes), markers and tracers are described in U.S. Pat. No. 6,054,122 and PCT Publication No. WO 2008/027821, and disinfectants (e.g., methylene blue) in U.S. Pat. Nos. 5,989,215, 6,074,663, and 6,461,325, all of which patents and publications are incorporated by reference herein in their entirety.

It is possible that such agents or additives may be premixed with one or more of the components, such as fibrinogen and/or thrombin in the respective component container. Alternatively, it may be possible for such agents or additives to be stored in a separate container (such as the container 260) as a liquid or lyophilized for mixing with one or more components during use of the dispenser and/or mixer. As a still further alternative, the agents or additives may be contained in a cartridge that is disposed in the flow line upstream of the mixer.

For a dispenser or mixer, such as in any of the above described embodiments, in which one or more of agents are employed, the combination preferably provides a sufficiently thoroughly mixed sealant, such as fibrin sealant, in which the antibiotic, drug, hormone, or other agents may be essentially well dispersed throughout the sealant. Such antibiotic, drug, hormone, or other agent may allow controlled release over time to the applied working surface, for example, to aid in post-operative or surgical treatment. It is contemplated that various agents may be employed depending on the desired application and the combined fluid stream.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

I claim:

1. A system comprising:
a source of at least a first component; and
a mixer having an inlet coupled to the source of at least a first component and an outlet, the mixer including at least one mixing device and a source of at least a second component disposed between the inlet and the outlet,
the at least one mixing device comprising a three-dimensional lattice defining a plurality of tortuous, interconnecting passages therethrough,
the at least one mixing device having physical characteristics to sufficiently mix the first and second components, which characteristics include a selected one or more of mean flow pore size, thickness and porosity.

2. The system of claim 1, wherein the mixer comprises a barrier and the at least one mixing device, the barrier and the at least one mixing device spaced from each other along a passageway between the inlet and the outlet to define a volume therebetween with the source of at least a second component disposed in the volume.

3. The system of claim 2, wherein the barrier comprises a mixing device, the mixing device comprising a three-dimensional lattice defining a plurality of tortuous, interconnecting passages therethrough, and having physical characteristics to sufficiently mix the first and second components, which characteristics include a selected one or more of mean flow pore size, thickness and porosity.

4. The system of claim 2, wherein the source of at least a second component is freeze-dried in the volume.

5. The system of claim 1, wherein the mixer comprises a single mixing device with the source of at least a second component immobilized therein.

6. The system of claim 5, wherein the source of at least a second component is freeze-dried inside the plurality of tortuous, interconnecting passages of the mixing device.

7. The system of claim 5, wherein the source of at least a second component is adsorbed to the surface of the plurality of tortuous, interconnecting passages of the mixing device.

8. The system of claim 1, wherein the second mixing device has a K value within the range of about 5 to 1000, as measured by Darcy's Law:
K=Q*η*L/(S*ΔP)
where Q=flow rate of the combined fluid stream,
η=viscosity of the more viscous of the first and second components,
L=thickness of the second mixing device,
S=surface area of the second mixing device, and
ΔP=change in pressure across the second mixing device.

9. The system of claim 1, wherein the first component is fibrinogen and the second component is thrombin.

10. The system of claim 1, wherein the source of at least a first component comprises a first component and a third component.

11. The system of claim 1, wherein the source of at least a second component comprises a second component and a third component.

12. A dispenser kit comprising:
a source of at least a first component; and
a mixer adapter having an inlet adapted to be coupled to the source of at least a first component and an outlet, the mixer adapter including at least one mixing device and a source of at least a second component disposed between the inlet and the outlet,
the at least one mixing device comprising a three-dimensional lattice defining a plurality of tortuous, interconnecting passages therethrough,
the at least one mixing device having physical characteristics to sufficiently mix the first and second components, which characteristics include a selected one or more of mean flow pore size, thickness and porosity.

13. The dispenser kit of claim 12, wherein the mixer adapter comprises a barrier and the at least one mixing device, the barrier and the at least one mixing device spaced from each other along a passageway between the inlet and the outlet to define a volume therebetween with the source of at least a second component disposed in the volume.

14. The dispenser kit of claim 13, wherein the barrier comprises a mixing device, the mixing device comprising a three-dimensional lattice defining a plurality of tortuous, interconnecting passages therethrough, and having physical characteristics to sufficiently mix the first and second components, which characteristics include a selected one or more of mean flow pore size, thickness and porosity.

15. The dispenser kit of claim 12, wherein the mixer comprises a single mixing device with the source of at least a second component immobilized therein.

16. The dispenser kit of claim 15, wherein the source of at least a second component is freeze-dried inside the plurality of tortuous, interconnecting passages of the mixing device.

17. The dispenser kit of claim 15, wherein the source of at least a second component is adsorbed to the surface of the plurality of tortuous, interconnecting passages of the mixing device.

18. A mixer adapter having an inlet adapted to be coupled to the source of at least a first component and an outlet, the mixer adapter comprising:
at least one mixing device and a source of at least a second component disposed between the inlet and the outlet,
the at least one mixing device comprising a three-dimensional lattice defining a plurality of tortuous, interconnecting passages therethrough,
the at least one mixing device having physical characteristics to sufficiently mix the first and second components, which characteristics include a selected one or more of mean flow pore size, thickness and porosity.

19. The mixer adapter of claim 18, comprising a barrier and the at least one mixing device, the barrier and the at least one mixing device spaced from each other along a passageway between the inlet and the outlet to define a volume therebetween with the source of at least a second component disposed in the volume.

20. The mixer adapter of claim 18, comprising a single mixing device with the source of at least a second component immobilized therein.
